(19) United States
(12) Patent Application Publication
(10) Pub. No.: US 2017/0212742 A1
(43) Pub. Date: Jul. 27, 2017

(54) METHOD FOR MANAGING SOFTWARE RELATED TO HARDWARE MOUNTED ONTO VEHICLE AND SYSTEM USING THE SAME

(71) Applicant: Obigo Inc., Gyeonggi-do (KR)

(72) Inventors: Jung Seok Lee, Gyeonggi-do (KR); Ki Hyun Jo, Seoul (KR)

(21) Appl. No.: 15/006,436

(22) Filed: Jan. 26, 2016

(51) Int. Cl. G06F 9/445; H04L 29/08

(52) U.S. Cl. CPC G06F 8/61; H04L 67/12; H04L 67/34

(57) ABSTRACT

A method for managing software related to hardware mounted onto a vehicle is provided. The method includes, comprising steps of: allowing a peripheral detector to recognize new hardware, acquire meta information on the hardware, and transmit the acquired meta information to a software coordinator, if the hardware is mounted onto the vehicle; allowing the software coordinator or a cloud communicator connected with the software coordinator to determine whether software related to the hardware exists in a storage device in the vehicle by referring to the meta information; and allowing the software coordinator or the cloud communicator (i) to access information on the software if the software is determined to exist in the storage device in the vehicle or (ii) to access the software by acquiring it from a server and storing it in the storage device if the software is determined not to exist in the storage device.

### FIELD OF THE INVENTION

The present invention relates to a method for managing software related to hardware mounted onto a vehicle and a system using the same; and more particularly, to the method and the system for automatically searching for software appropriate for new hardware if the new hardware is mounted onto a vehicle under a plug-and-play (PnP) vehicle system environment and allowing the new hardware and the searched software to operate.

### BACKGROUND OF THE INVENTION

Recently as IT has been developed, studies on the field of smart cars have been actively conducted.

To integrate such a variety of IT services with a vehicle, new hardware module may be mounted onto vehicle system and software related to the new module must be installed to drive it. However, the software related to the newly mounted module had to be installed by a human in the past and it was inconvenient to check the operation of the new hardware module to ensure that the software is properly installed.

Thus, the present inventor intends to propose a technology for allowing a vehicle system to detect a new hardware module mounted onto a vehicle as well as to automatically operate it without setting software manually.

### SUMMARY OF THE INVENTION

It is an object of the present invention to operate hardware and software corresponding thereto, if the hardware is mounted onto a vehicle system, by automatically analyzing the characteristics of the hardware and searching for the software appropriate for the hardware.

It is another object of the present invention to allow a user to control the hardware mounted onto a vehicle easily by providing reference information on individual modules of software corresponding to hardware modules included in the newly mounted hardware.

In accordance with one example embodiment of the present invention, there is provided a method for managing software related to hardware mounted onto a vehicle, including steps of: (a) a processor allowing a peripheral detector to recognize new hardware, acquire meta information on the hardware, and transmit the acquired meta information to a software coordinator, if the hardware is mounted onto the vehicle; (b) the processor allowing the software coordinator or a cloud communicator connected with the software coordinator to determine whether software related to the hardware exists in a storage device in the vehicle by referring to the meta information transmitted to the software coordinator; and (c) the processor allowing the software coordinator or the cloud communicator (i) to access information on the software if the software is determined to exist in the storage device in the vehicle or (ii) to access the software by acquiring it from a server and storing it in the storage device in the vehicle if the software is determined not to exist in the storage device in the vehicle.

In accordance with one example embodiment of the present invention, there is provided a vehicle system for managing software related to hardware mounted onto a vehicle, including: a processor for (i) allowing a peripheral detector to recognize new hardware, acquire meta information on the hardware and transmit the acquired meta information to a software coordinator if the hardware is mounted onto the vehicle, and (ii) allowing the software coordinator or a cloud communicator connected with the software coordinator to determine whether software related to the hardware exists in a storage device in the vehicle by referring to the meta information transmitted to the software coordinator; and a communication part for (i) allowing information on the software to be accessed if the software is determined to exist or (ii) acquiring the software from a server and store it in the storage device in the vehicle to access if the software is determined not to exist in the storage device in the vehicle, by using a communication module included in the software coordinator or the cloud communicator.

### BRIEF DESCRIPTION OF THE DRAWINGS

The above and other objects and features of the present invention will become apparent from the following description of preferred embodiments given in conjunction with the accompanying drawings, in which:

FIG. 1 is a drawing showing an exemplary configuration of a whole system to manage software related to hardware mounted onto a vehicle in accordance with one example embodiment of the present invention.

FIG. 2 is a drawing illustrating an internal configuration of a vehicle system in details in accordance with one example embodiment of the present invention.

FIG. 3 is a drawing exemplarily explaining that software related to hardware mounted onto a vehicle is acquired from a server in accordance with one example embodiment of the present invention.

FIG. 4 is a drawing exemplarily showing that reference information on individual modules of software is managed in accordance with one example embodiment of the present invention.

FIG. 5 is an exemplary drawing representing that reference information on individual modules of software is displayed through a display device in a vehicle in accordance with one example embodiment of the present invention.

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention. In addition, it is to be understood that the position or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

To allow those skilled in the art to the present invention to be carried out easily, the example embodiments of the present invention by referring to attached drawings will be explained in detail as follows:

FIG. 1 is a drawing showing an exemplary configuration of a whole system to manage software related to hardware mounted onto a vehicle in accordance with one example embodiment of the present invention.

As illustrated in FIG. 1, a whole system in accordance with one example embodiment of the present invention include a vehicle system 100, a server 200, and a communication network 300.

First of all, the vehicle system 100 in accordance with one example embodiment of the present invention may be a digital device that includes a function of being capable of communicating with the server 200 after accessing it. A digital device such as a smart cluster, an on-board display device, a navigation system, an ECU, etc. that have memory means and a micro processor 110 with a calculation ability may be adopted as the vehicle system 100 in accordance with the present invention at any time.

The vehicle system 100 in accordance with one example embodiment of the present invention may have a function of plug & play (PnP) and automatically recognize new hardware if the hardware is mounted onto the vehicle. If hardware, e.g., a vision sensor, forward and rear monitoring systems, forward and rear view cameras, GPS antenna upgrade, TPMS modules, etc., is mounted onto the vehicle, the vehicle system 100 could recognize it and acquire information on the mounted hardware.

The configuration and functions of the vehicle system 100 in accordance with the present invention will be explained in details below.

Next, if a request for software related to hardware mounted onto the vehicle is received from the vehicle system 100, the server 200 may perform a function of providing the software to the vehicle system 100. Besides, the server 200 could also perform a function of providing information on a list of at least one piece of software that satisfies a certain condition among pieces of software related to the hardware mounted onto the vehicle to the vehicle system 100. Herein, the software that satisfies the certain condition could be top n pieces of software that are most frequently downloaded during a specified period or could be top m pieces of preferred software that are classified by a driver's gender, age, etc. but is not limited to this.

The communication network 300 in accordance with one example embodiment of the present invention may be configured regardless of wired or wireless communication and may be configured in a form of a wide area network (WAN), a local area network (LAN), a telecommunication network, an artificial satellite communication network and other diverse networks. More preferably, the communication network 300 in the present invention may include wireless communication networks implemented by technologies such as IEEE 802.11, code division multiple access (CDMA), wideband code division multiple access (WCDMA), global system for mobile communications (GSM), and long term evolution (LTE). However, the communication network 300 may also include at least part of a publicly known wireless communication network or a publicly known telephone network without being limited only to these.

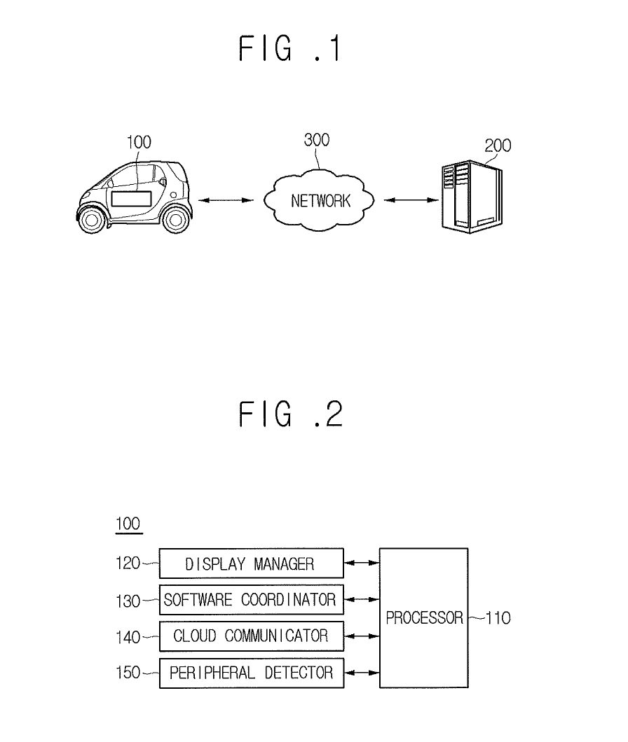

FIG. 2 is a drawing illustrating an internal configuration of the vehicle system 100 in details in accordance with one example embodiment of the present invention.

As illustrated in FIG. 2, the vehicle system 100 in accordance with one example embodiment of the present invention may include a display manager 120, a software coordinator 130, a cloud communicator 140, a peripheral detector 150 and a processor 110. Herein, all of the display manager 120, the software coordinator 130, the cloud communicator 140, the peripheral detector 150, and the processor 110 are not required to be physically included in the vehicle system 100, and could be placed on its outside connected with the vehicle system 100. Meanwhile, in accordance with one example embodiment of the present invention, at least some of the display manager 120, the software coordinator 130, the cloud communicator 140, the peripheral detector 150, and the processor 110 may be program modules communicated with the server 200. Such program modules may be included in the vehicle system 100 in a form of operating system, application program module and other program module or physically stored in various storage devices well known to those skilled in the art. They may be also stored in a remote storage device capable of communicating with the vehicle system 100. Such program modules may include but not be subject to a routine, a subroutine, a program, an object, a component, and a data structure for executing a specific operation or a type of specific abstract data that will be described in accordance with the present invention.

First of all, if new hardware is mounted onto the vehicle, the peripheral detector 150 in accordance with one example embodiment of the present invention could recognize the hardware, acquire meta information on the hardware, and transmit the acquired meta information to the software coordinator 130. In particular, the peripheral detector 150 could automatically recognize the newly mounted hardware.

Next, the software coordinator 130 in accordance with one example embodiment of the present invention may determine whether software related to hardware exists in a storage device in the vehicle by referring to the meta information transmitted from the peripheral detector 150 and if the software is determined to exist in the storage device in the vehicle, it may be accessible to information on the software. In addition, if the software coordinator 130 includes a communication module and if software is determined not to exist in the storage device in the vehicle, the software coordinator 130 may acquire the software from the server 200, store the acquired software from the server 200 in the storage device in the vehicle and then access it. Herein, the software coordinator 130 being set to access the information on the software means setting an access path for allowing the hardware mounted onto the vehicle to access the information on the software.

The cloud communicator 140 in accordance with another example embodiment of the present invention may communicate with the software coordinator 130 and the software coordinator 130 may transmit only the meta information to the cloud communicator 140 and may not determine whether the software related to hardware exists in the storage device in the vehicle. Instead, if the cloud communicator 140 includes a communication module, the cloud communicator 140 may determine whether the software related to the hardware exists in the storage device in the vehicle by acquiring meta information from the software coordinator 130 and if the software is determined to exist in the storage device in the vehicle, the information on the software could be accessed or if the software is determined not to exist in the storage device in the vehicle, it could be accessed after acquiring the software from the server 200 and storing it in the storage device in the vehicle.

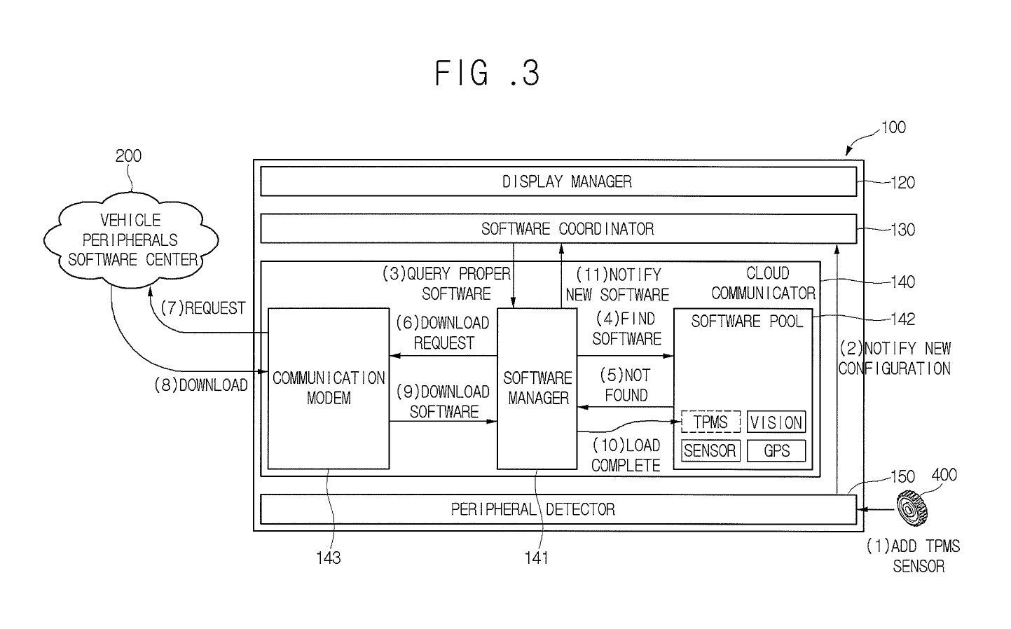

The cloud communicator 140 in accordance with one example embodiment of the present invention could also include a software manager 141, a communication modem 143, and a storage device 142 in the vehicle (so-called a software pool 142). In this case, the software manager 141 may also determine whether the software exists in the storage device in the vehicle by referring to the meta information and if the software is determined not to exist in the storage device in the vehicle, the software manager 141 could also acquire the software from the server 200 through the communication modem 143 and store it in the storage device in the vehicle. In relation to this, more explanation will be made by referring to FIG. 3.

If the software related to the hardware mounted onto the vehicle is determined to exist in the storage device in the vehicle, the software coordinator 130 or the cloud communicator 140 in accordance with one example embodiment of the present invention may acquire information on a list of at least one piece of software that satisfies a certain condition and transmit the information to the display manager 120.

The display manager 120 that has received the information on the list could display the information on the list through the display device in the vehicle and through this, a user could select software.

After that, if a user's input for selecting peculiar software among the at least one piece of software is acquired through the display device, the software coordinator 130 or the cloud communicator 140 could also set the hardware to access the peculiar software.

Similarly, even if the software is determined not to exist in the storage device in the vehicle, the software coordinator 130 or the cloud communicator 140 could also acquire information on a list of the at least one piece of software that satisfies a certain condition from the server 200 and transmit it to the display manager 120 and the display manager 120 could display the acquired information on the list through the display device in the vehicle. After that, if a user's input for selecting peculiar software through the display device is acquired, the software coordinator 130 or the cloud communicator 140 could acquire the peculiar software from the server 200, store it in the storage device in the vehicle, and set the hardware to access the peculiar software.

Besides, if the software related to the hardware mounted onto the vehicle has not been installed, the software coordinator 130 or the cloud communicator 140 could install the software within a specific time. In other case, if a request for installing the software is made by the user of the vehicle, the software coordinator 130 or the cloud communicator 140 could install the software.

If software is newly acquired from the server 200 and stored in the storage device in the vehicle, the software coordinator 130 in accordance with one example embodiment of the present invention may acquire reference information on individual modules of software existing in the storage device in the vehicle and configure a vehicle software map by using the acquired reference information.

Herein, the reference information may include information on a category the reference information belongs to, a software access path corresponding to the reference information, and information on setting for executing software corresponding to the reference information.

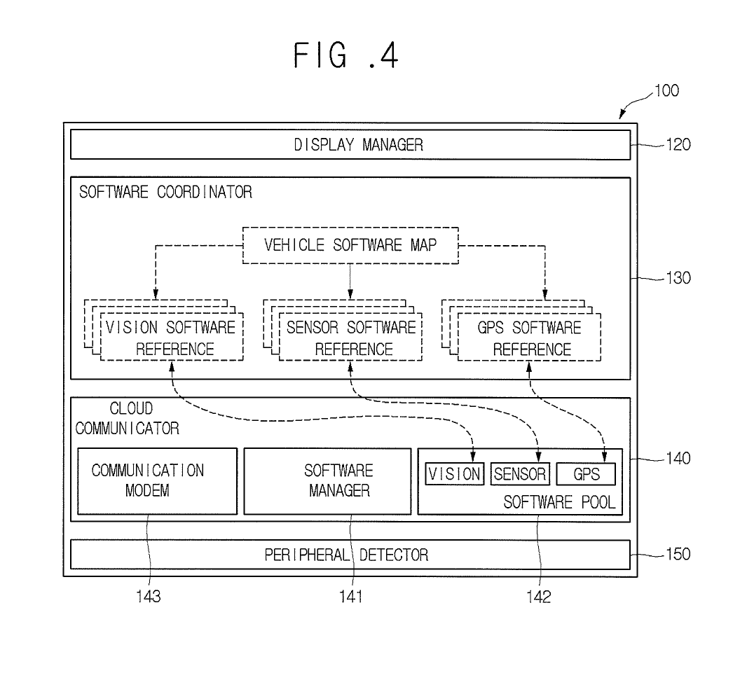

The software coordinator 130 may configure the vehicle software map whose category could be classified by using the reference information on the individual modules of the software. This will be more specifically explained through FIG. 4.

After configuring the vehicle software map by using the acquired reference information, the software coordinator 130 may transmit information on the newly acquired software to the display manager 120 and the display manager 120 may display the information on the newly acquired software through the display device in the vehicle. This may enable the user to check the information on the newly added software.

In addition, the software coordinator 130 may transmit information on the vehicle software map to the display manager 120 and the display manager 120 may display the reference information on the individual modules of the software through the display device in the vehicle by referring to the vehicle software map.

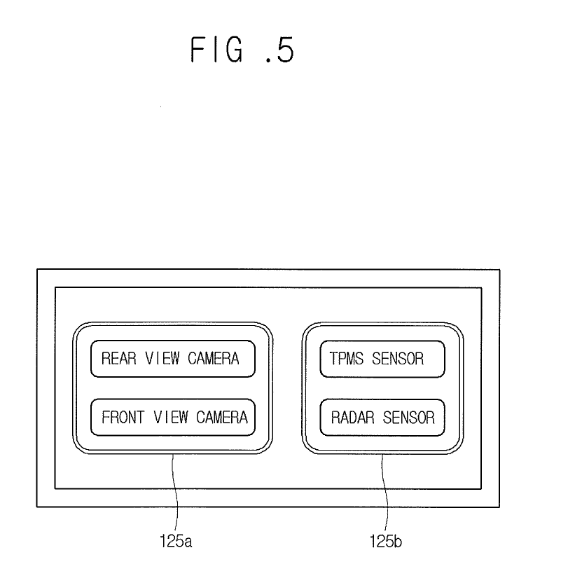

After that, if an input for selecting specified reference information among the pieces of reference information on the individual modules of the software is acquired through the display device in the vehicle, the software coordinator 130 could set prescribed hardware corresponding to the specified reference information to be controlled by referring to the specified reference information. In relation to these, more explanation will be made through FIG. 5.

The processor 110 in accordance with one example embodiment of the present invention may perform a function of supporting the display manager 120, the software coordinator 130, the cloud communicator 140, and the peripheral detector 150 and also could instruct the display manager 120, the software coordinator 130, the cloud communicator 140, and the peripheral detector 150 directly or indirectly to perform the individual processes as described above.

FIG. 3 is a drawing exemplarily explaining that software related to hardware mounted onto a vehicle is acquired by the vehicle system 100 from the server 200 in accordance with one example embodiment of the present invention

FIG. 3 exemplarily shows that the cloud communicator 140 includes the software manager 141, the communication modem 143, and the storage device in the vehicle. The software pool 142 may exist in the storage device as seen above.

To explain by referring to the order of the processes illustrated in FIG. 3, if a TPMS sensor 400 is mounted as a new module (1. ADD TPMS SENSOR 400), the peripheral detector 150 could acquire meta information on the TPMS sensor 400 by recognizing the hardware, transmit the meta information on the TPMS sensor 400 to the software coordinator 130, and notify a new configuration with respect to the TPMS sensor 400 (2. NOTIFY NEW CONFIGURATION).

After that, the software coordinator 130 could transmit the meta information on the TPMS sensor 400 to the software manager 141 to check whether software regarding the TPMS sensor 400 exists in the storage device in the vehicle (3. QUERY PROPER SOFTWARE) and the software manager 141 could check whether the software regarding the TPMS sensor 400 exists in the software pool 142 (4. FIND SOFTWARE). If the software is determined not to exist (5. NOT FOUND), the software manager 141 could request the communication modem 143 to download the software regarding the TPMS sensor 400 (6. DOWNLOAD REQUEST).

The communication modem 143 could request the server 200, i.e., Vehicle Peripheral Software Center, to download the software regarding the TPMS sensor 400 (7. REQUEST). After the software regarding the TPMS sensor 400 is downloaded from the server 200 (8. DOWNLOAD), the communication modem 143 could transmit it to the software manager 141 (9. DOWNLOAD SOFTWARE).

The software manager 141 could store the software regarding the TPMS sensor 400 in the software pool 142 (10. LOAD COMPLETE), and could notify the software coordinator 130 of the fact that the software has been downloaded (11. NOTIFY NEW SOFTWARE).

If the required software exists in the software pool 142, the software manager 141 could also notify the software coordinator 130 of the fact that the software regarding the TPMS sensor 400 exists in the software pool 142.

FIG. 4 is a drawing exemplarily showing that reference information on individual modules of software is managed in accordance with one example embodiment of the present invention.

FIG. 4 exemplarily shows that the cloud communicator 140 includes the software manager 141, the communication modem 143, and the storage device (including the software pool 142) in the vehicle.

To explain by referring to FIG. 4, if software is newly acquired from the server 200 and stored in the storage device in the vehicle, the software coordinator 130 could acquire reference information on the individual modules of the software existing in the software pool 142 through the software manager 141, and form a vehicle software map whose category could be classified by using the acquired reference information.

Herein, the reference information may include information on a category the reference information belongs to, a software access path corresponding to the reference information, and information on setting for executing a module of the software corresponding to the reference information. For example, individual modules of software related to visions among pieces of software existing in the software pool 142 could include a rear view camera software module, a front view camera software module, etc. and the software coordinator 130 could form the vehicle software map by acquiring the reference information on the rear view camera software module, the front view camera software module, etc.

If the vehicle software map has been completely formed, the software coordinator 130 could also notify the display manager 120 of information on the changed item, e.g., information on the newly added software.

Besides, the software coordinator 130 could also transmit the information on the vehicle software map to the display manager 120. The display manager 120 may display the reference information on the individual modules of the software through the display device in the vehicle by referring to the information on the vehicle software map transmitted from the software coordinator 130. This will be explained by referring to FIG. 5.

FIG. 5 exemplarily illustrates that the display manager 120 displays the reference information on the individual modules of the software through the display device.

More specifically, the display manager 120 could display reference information 125A on individual modules, e.g., the rear view camera module and the front view camera module, of the vision software and reference information 125B on individual modules, e.g., a software module for the TPMS sensor 400 and a software module for the laser sensor, of sensor software through the display device and if an input for selecting specified reference information among the pieces of the reference information displayed through the display device is acquired through the display device in the vehicle, the software coordinator 130 could set prescribed hardware corresponding to the specified reference information to be controlled by referring to the specified reference information. For example, if an input for selecting the reference information on the software module for the rear view camera is acquired, the software coordinator 130 could set a software access path corresponding to the rear view camera module to control the rear view camera module by referring to the reference information on the software module for the rear view camera module.

In accordance with the present invention, if hardware is mounted onto a vehicle system, it is possible to operate the hardware and software corresponding thereto by allowing the software corresponding thereto to be automatically searched and operated.

Besides, in accordance with the present invention, it is possible to allow the user to easily control hardware newly mounted onto the vehicle by providing the reference information on the individual modules of the software corresponding to individual hardware modules of the newly mounted hardware.

The embodiments of the present invention as explained above can be implemented in a form of executable program command through a variety of computer means recordable to computer readable media. The computer readable media may include solely or in combination, program commands, data files, and data structures. The program commands recorded to the media may be components specially designed for the present invention or may be usable to a skilled person in a field of computer software. Computer readable record media include magnetic media such as hard disk, floppy disk, and magnetic tape, optical media such as CD-ROM and DVD, magneto-optical media such as floptical disk and hardware devices such as ROM, RAM, and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

As seen above, the present invention has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

What is claimed is:

1. A method for managing software related to hardware mounted onto a vehicle, comprising steps of:
(a) a processor allowing a peripheral detector to recognize new hardware, acquire meta information on the hardware, and transmit the acquired meta information to a software coordinator, if the hardware is mounted onto the vehicle;
(b) the processor allowing the software coordinator or a cloud communicator connected with the software coordinator to determine whether software related to the hardware exists in a storage device in the vehicle by referring to the meta information transmitted to the software coordinator; and
(c) the processor allowing the software coordinator or the cloud communicator (i) to access information on the software if the software is determined to exist in the storage device in the vehicle or (ii) to access the software by acquiring it from a server and storing it in the storage device in the vehicle if the software is determined not to exist in the storage device in the vehicle.

2. The method of claim 1, wherein the cloud communicator includes a software manager, a communication modem, and the storage device in the vehicle; and wherein the software manager determines whether the software exists in the storage device in the vehicle by referring to the meta information and acquires the software from the server through the communication modem and stores it in the storage device in the vehicle if the software is determined not to exist in the storage device in the vehicle.

3. The method of claim 1, further comprising a step of:
(d) the processor allowing the software coordinator or the cloud communicator to install the software within a specific time if the software has not been installed or if it is requested to be installed by a user of the vehicle.

4. The method of claim 1, wherein, if the software is determined to exist in the storage device in the vehicle, the step of (c) includes steps of:
(c1) the processor allowing the software coordinator or the cloud communicator to acquire information on a list of at least one piece of software that satisfies a certain condition from the storage device in the vehicle and allowing a display manager to display the acquired information on the list of the software through a display device in the vehicle; and
(c2) the processor allowing the software coordinator or the cloud communicator to set the hardware to access peculiar software if the peculiar software is selected among the at least one piece of software by the user through the display device.

5. The method of claim 1, wherein, if the software is determined not to exist in the storage device in the vehicle, the step of (c) includes steps of:
(c3) the processor allowing the software coordinator or the cloud communicator to acquire information on a list of at least one piece of software that satisfies a certain condition from the server and then to cause a display manager to display the acquired information on the list of the software through a display device in the vehicle; and
(c4) the processor allowing the software coordinator or the cloud communicator to acquire peculiar software, if the peculiar software is selected among the at least one piece of software by the user through the display device, from a server and store it in the storage device in the vehicle and then set the hardware to access the peculiar software.

6. The method of claim 1, wherein, if the software is newly acquired from the server and stored in the storage device in the vehicle, the processor allows the software coordinator to acquire reference information on individual modules of the software existing in the storage device in the vehicle and form a vehicle software map by using the acquired reference information.

7. The method of claim 6, wherein the reference information includes information on a category the reference information belongs to, a software access path corresponding to the reference information, and information on setting for executing a module of the software corresponding to the reference information.

8. The method of claim 6, wherein the processor allows the software coordinator to transmit information on the newly acquired software to the display manager and allows the display manager to display the information on the newly acquired software through the display device in the vehicle.

9. The method of claim 6, wherein the processor allows the software coordinator to transmit information on the vehicle software map to the display manager and allows the display manager to display the reference information on individual modules of the software through the display device in the vehicle by referring to the information on the vehicle software map.

10. The method of claim 9, wherein, if an input for selecting specified reference information among pieces of the reference information on individual modules of the software is acquired through the display device in the vehicle, the processor supports the software coordinator to set prescribed hardware corresponding to the specified reference information to be controlled by referring to the specified reference information.

11. A vehicle system for managing software related to hardware mounted onto a vehicle, comprising:
a processor for (i) allowing a peripheral detector to recognize new hardware, acquire meta information on the hardware and transmit the acquired meta information to a software coordinator if the hardware is mounted onto the vehicle, and (ii) allowing the software coordinator or a cloud communicator connected with the software coordinator to determine whether software related to the hardware exists in a storage device in the vehicle by referring to the meta information transmitted to the software coordinator; and
a communication part for (i) allowing information on the software to be accessed if the software is determined to exist or (ii) acquiring the software from a server and store it in the storage device in the vehicle to access if the software is determined not to exist in the storage device in the vehicle, by using a communication module included in the software coordinator or the cloud communicator.

12. The system of claim 11, wherein the cloud communicator includes a software manager, a communication modem, and the storage device in the vehicle; and wherein the software manager determines whether the software exists in the storage device in the vehicle by referring to the meta information and it acquires the software from the server through the communication modem and stores it in the storage device in the vehicle if the software is determined not to exist in the storage device in the vehicle.

13. The system of claim 11, wherein, if the software has not been installed or it is requested to be installed by a user of the vehicle, the software coordinator or the cloud communicator installs the software within a specific time.

14. The system of claim 11, wherein, if the software is determined to exist in the storage device in the vehicle, the software coordinator or the cloud communicator acquires information on a list of at least one piece of software that satisfies a certain condition from the storage device in the vehicle and transmits the information to a display manager; and wherein the display manager displays the acquired information on the list through a display device in the vehicle and if peculiar software is selected among the at least one piece of software by a user of the vehicle through the display device, the software coordinator or the cloud communicator sets the hardware to access the peculiar software.

15. The system of claim 11, wherein, if the software is determined not to exist in the storage device in the vehicle, the software coordinator or the cloud communicator acquires information on a list of at least one piece of software that satisfies a certain condition from the server and transmits the information to the display manager; and wherein the display manager displays the acquired information on the list through the display device in the vehicle and if peculiar software is selected among the at least one piece of software by a user of the vehicle through the display device, the software coordinator or the cloud communicator acquires the peculiar software from the server, stores it in the storage device in the vehicle, and sets the hardware to access it.

16. The system of claim 11, wherein, if the software is newly acquired from the server and stored in the storage device in the vehicle, the software coordinator acquires reference information on individual modules of the software existing in the storage device in the vehicle and forms a vehicle software map by using the acquired reference information.

17. The system of claim 16, wherein the reference information includes information on a category the reference information belongs to, a software access path corresponding to the reference information, and information on setting for executing a module of the software corresponding to the reference information.

18. The system of claim 16, wherein the software coordinator transmits information on the newly acquired software to a display manager and the display manager displays the information on the newly acquired software through the display device in the vehicle.

19. The system of claim 16, wherein the software coordinator transmits information on the vehicle software map to a display manager and the display manager displays reference information on individual modules of the software by referring to the information on the vehicle software map through the display device in the vehicle.

20. The system of claim 19, wherein, if an input for selecting specified reference information among pieces of the reference information on individual modules of the software is acquired through the display device in the vehicle, the software coordinator sets prescribed hardware corresponding to the specified reference information to be controlled by referring to the specified reference information.
